(19) United States
(12) Patent Application Publication
(10) Pub. No.: US 2025/0097693 A1
(43) Pub. Date: Mar. 20, 2025

(54) REPORTING COMMON TIMING ADVANCE CONFIGURATION CAPABILITIES

(71) Applicant: QUALCOMM Incorporated, San Diego, CA (US)

(72) Inventors: Fang YUAN, Beijing (CN); Yan ZHOU, San Diego, CA (US); Mostafa KHOSHNEVISAN, San Diego, CA (US); Shaozhen GUO, Beijing (CN); Tao LUO, San Diego, CA (US); Xiaoxia ZHANG, San Diego, CA (US); Peter GAAL, San Diego, CA (US); Junyi LI, Greentown, PA (US)

(21) Appl. No.: 18/729,352

(22) PCT Filed: Mar. 10, 2022
(86) PCT No.: PCT/CN2022/080101

§ 371 Date: Jul. 16, 2024

(51) Int. Cl. H04W 8/24; H04W 76/15

(52) U.S. Cl. CPC H04W 8/24; H04W 76/15

(57) ABSTRACT

In some implementations, a user equipment (UE) may transmit, to a network entity, a report associated with a UE capability for supporting a common timing advance (TA) configuration, wherein the report indicates one or more of: a supported TA type that includes one of an independent TA or a common TA; or a quantity of timing advance groups (TAGs) for a carrier aggregation. The UE may receive, from the network entity, a TA configuration based at least in part on the report.

### FIELD OF THE DISCLOSURE

Aspects of the present disclosure generally relate to wireless communication and to techniques and apparatuses for reporting common timing advance (TA) configuration capabilities.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: transmit, to a network entity, a report associated with a UE capability for supporting a common timing advance (TA) configuration, wherein the report indicates one or more of: a supported TA type that includes one of an independent TA or a common TA; or a quantity of timing advance groups (TAGs) for a carrier aggregation; and receive, from the network entity, a TA configuration based at least in part on the report.

In some implementations, an apparatus for wireless communication at a network entity includes a memory and one or more processors, coupled to the memory, configured to: receive, from a UE, a report associated with a UE capability for supporting a common TA configuration, wherein the report indicates one or more of: a supported TA type that includes one of an independent TA or a common TA; or a quantity of TAGs for a carrier aggregation; and transmit, to the UE, a TA configuration based at least in part on the report.

In some implementations, a method of wireless communication performed by a UE includes transmitting, to a network entity, a report associated with a UE capability for supporting a common TA configuration, wherein the report indicates one or more of: a supported TA type that includes one of an independent TA or a common TA; or a quantity of TAGs for a carrier aggregation; and receiving, from the network entity, a TA configuration based at least in part on the report.

In some implementations, a method of wireless communication performed by a network entity includes receiving, from a UE, a report associated with a UE capability for supporting a common TA configuration, wherein the report indicates one or more of: a supported TA type that includes one of an independent TA or a common TA; or a quantity of TAGs for a carrier aggregation; and transmitting, to the UE, a TA configuration based at least in part on the report.

In some implementations, a non-transitory computer-readable medium storing a set of instructions for wireless communication includes one or more instructions that, when executed by one or more processors of a UE, cause the UE to: transmit, to a network entity, a report associated with a UE capability for supporting a common TA configuration, wherein the report indicates one or more of: a supported TA type that includes one of an independent TA or a common TA; or a quantity of TAGs for a carrier aggregation; and receive, from the network entity, a TA configuration based at least in part on the report.

In some implementations, a non-transitory computer-readable medium storing a set of instructions for wireless communication includes one or more instructions that, when executed by one or more processors of a network entity, cause the network entity to: receive, from a UE, a report associated with a UE capability for supporting a common TA configuration, wherein the report indicates one or more of: a supported TA type that includes one of an independent TA or a common TA; or a quantity of TAGs for a carrier aggregation; and transmit, to the UE, a TA configuration based at least in part on the report.

In some implementations, an apparatus for wireless communication includes means for transmitting, to a network entity, a report associated with an apparatus capability for supporting a common TA configuration, wherein the report indicates one or more of: a supported TA type that includes one of an independent TA or a common TA; or a quantity of TAGs for a carrier aggregation; and means for receiving, from the network entity, a TA configuration based at least in part on the report.

In some implementations, an apparatus for wireless communication includes means for receiving, from a UE, a report associated with a UE capability for supporting a common TA configuration, wherein the report indicates one or more of: a supported TA type that includes one of an independent TA or a common TA; or a quantity of TAGs for a carrier aggregation; and means for transmitting, to the UE, a TA configuration based at least in part on the report.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a disaggregated base station architecture, in accordance with the present disclosure.

FIG. 4 is a diagram illustrating an example of multiple transmission reception point (multi-TRP) operations, in accordance with the present disclosure.

FIGS. 5-8 are diagrams illustrating examples associated with reporting common timing advance (TA) configuration capabilities, in accordance with the present disclosure.

FIG. 9 is a diagram illustrating an example associated with a multi-TRP configuration, in accordance with the present disclosure.

FIGS. 10-12 are diagrams illustrating examples associated with a timing advance group (TAG) configuration, in accordance with the present disclosure.

FIGS. 13-14 are diagrams illustrating example processes associated with reporting common TA configuration capabilities, in accordance with the present disclosure.

FIGS. 15-16 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

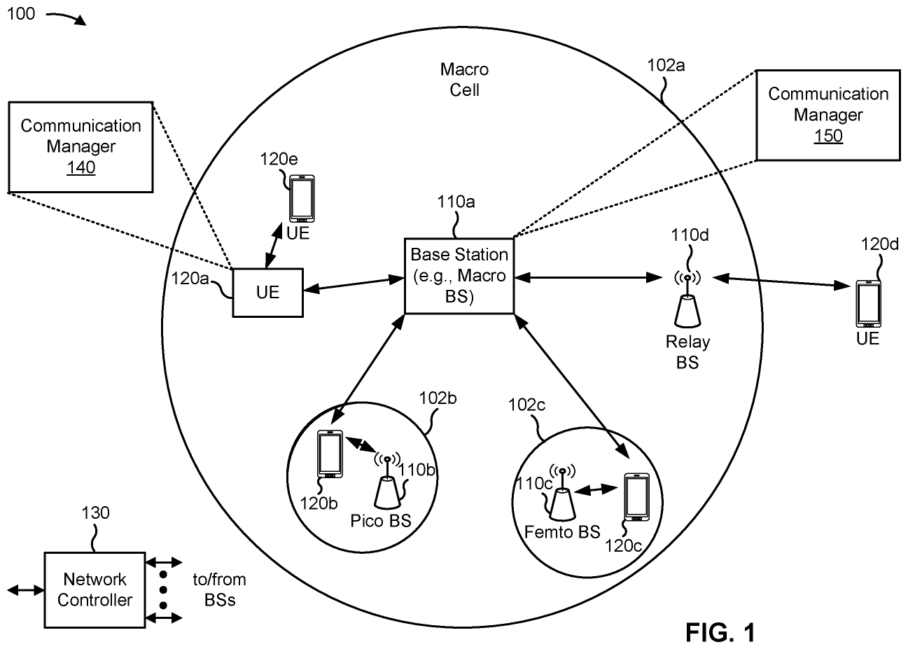

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may transmit, to a network entity, a report associated with a UE capability for supporting a common timing advance (TA) configuration, wherein the report indicates one or more of: a supported TA type that includes one of an independent TA or a common TA; or a quantity of timing advance groups (TAGs) for a carrier aggregation; and receive, from the network entity, a TA configuration based at least in part on the report. Additionally, or alternatively, the communication manager 140 may perform one or more other operations described herein.

In some aspects, a network entity (e.g., base station 110) may include a communication manager 150. As described in more detail elsewhere herein, the communication manager 150 may receive, from a UE, a report associated with a UE capability for supporting a common TA configuration, wherein the report indicates one or more of: a supported TA type that includes one of an independent TA or a common TA; or a quantity of TAGs for a carrier aggregation; and transmit, to the UE, a TA configuration based at least in part on the report. Additionally, or alternatively, the communication manager 150 may perform one or more other operations described herein.

As indicated above, FIG. 1 is provided as an example. Other examples may differ from what is described with regard to FIG. 1.

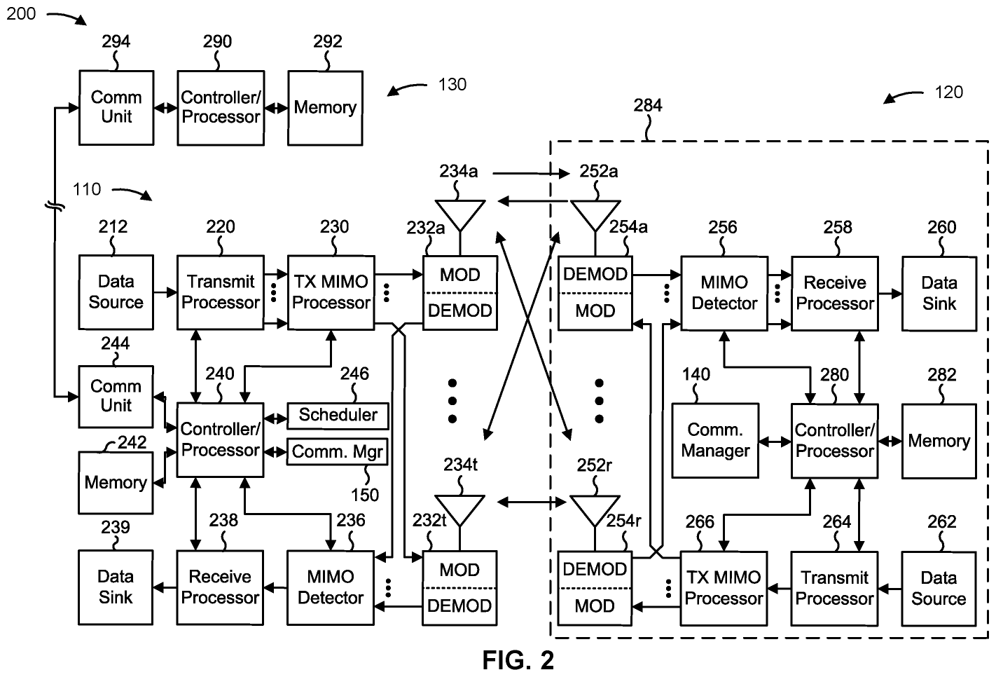

FIG. 2 is a diagram illustrating an example 200 of a base station 110 in communication with a UE 120 in a wireless network 100, in accordance with the present disclosure. The base station 110 may be equipped with a set of antennas 234a through 234t, such as T′ antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

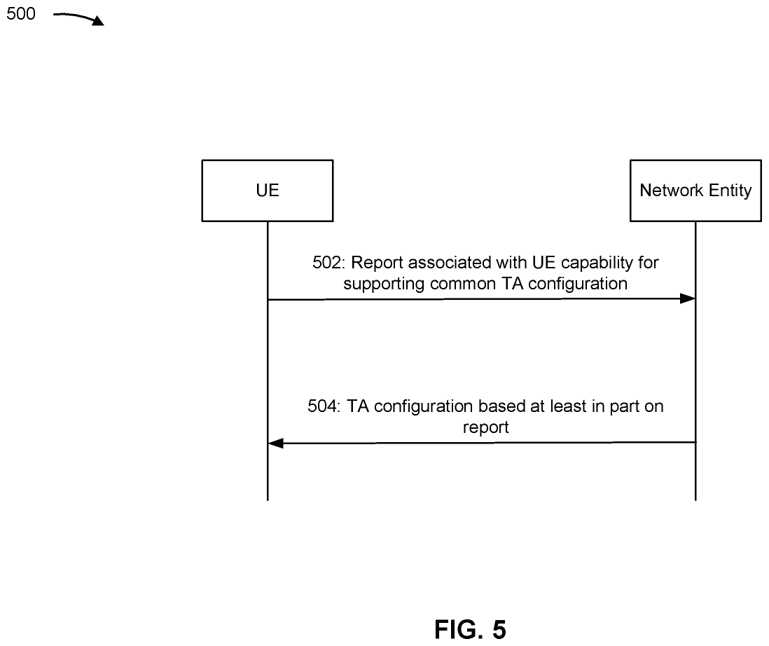

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-16).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-16).

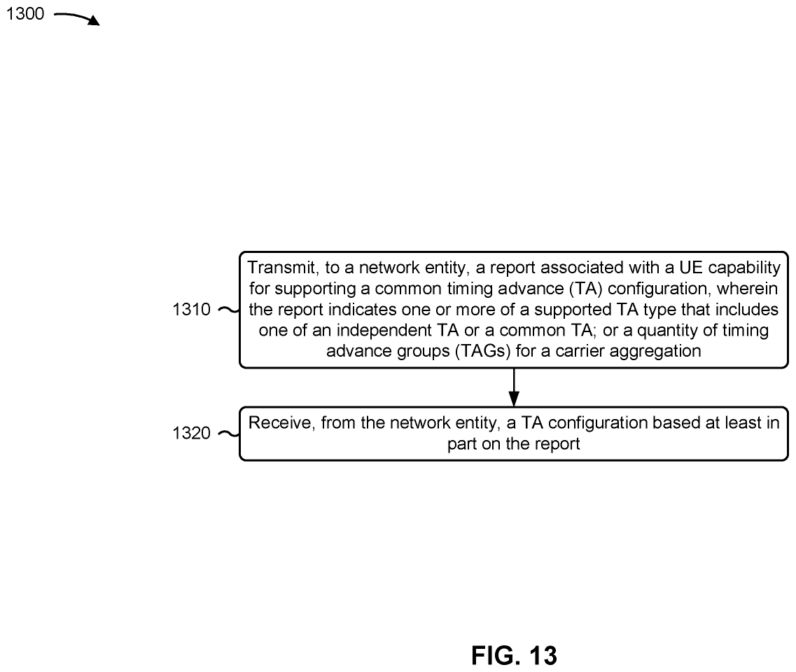

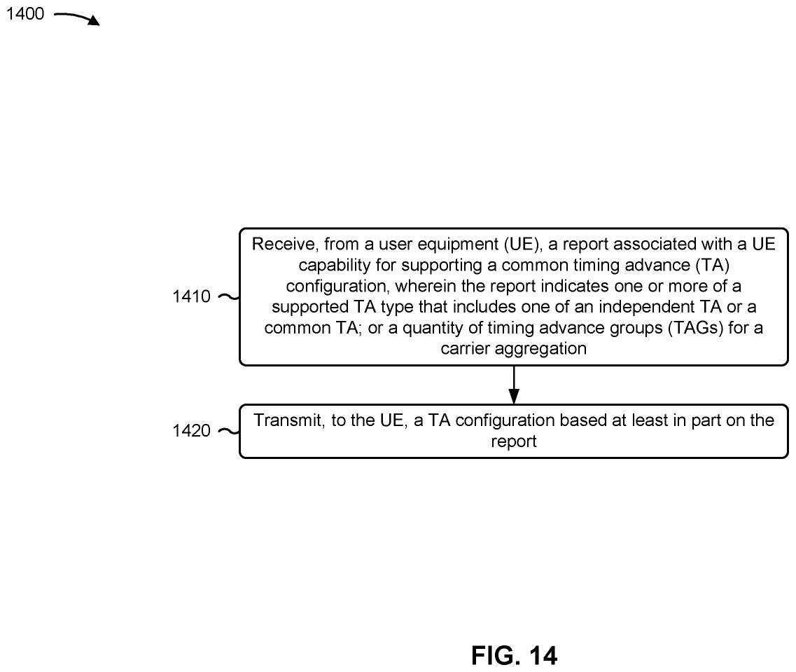

The controller/processor 240 of the base station 110, the controller/processor 280 of the UE 120, and/or any other component(s) of FIG. 2 may perform one or more techniques associated with reporting common TA configuration capabilities, as described in more detail elsewhere herein. For example, the controller/processor 240 of the base station 110, the controller/processor 280 of the UE 120, and/or any other component(s) of FIG. 2 may perform or direct operations of, for example, process 1300 of FIG. 13, process 1400 of FIG. 14, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1300 of FIG. 13, process 1400 of FIG. 14, and/or other processes as described herein. In some examples, executing instructions may include running the instructions, converting the instructions, compiling the instructions, and/or interpreting the instructions, among other examples.

In some aspects, a UE (e.g., UE 120) includes means for transmitting, to a network entity, a report associated with a UE capability for supporting a common TA configuration, wherein the report indicates one or more of: a supported TA type that includes one of an independent TA or a common TA; or a quantity of TAGs for a carrier aggregation; and/or means for receiving, from the network entity, a TA configuration based at least in part on the report. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., base station 110) includes means for receiving, from a UE, a report associated with a UE capability for supporting a common TA configuration, wherein the report indicates one or more of: a supported TA type that includes one of an independent TA or a common TA; or a quantity of TAGs for a carrier aggregation; and/or means for transmitting, to the UE, a TA configuration based at least in part on the report. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

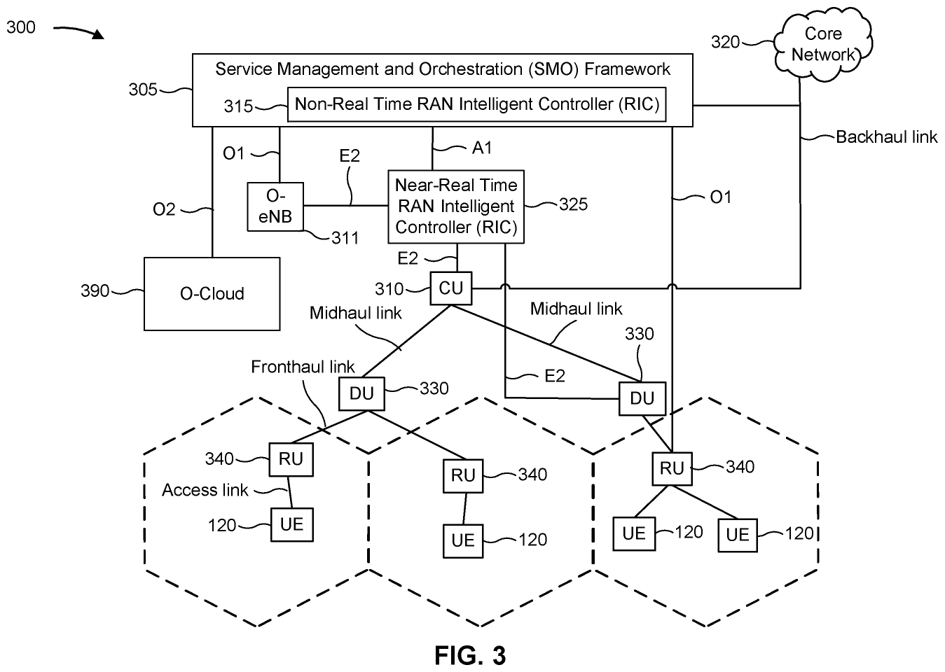

FIG. 3 is a diagram illustrating an example 300 of a disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an IAB network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As indicated above, FIG. 3 is provided as an example. Other examples may differ from what is described with regard to FIG. 3.

Two TA values may be supported for uplink multiple TRP (multi-TRP) operations. Uplink multi-TRP operations may be scheduled by multiple DCI (multi-DCI). In uplink multi-TRP operations, a first uplink transmission to a first TRP may be scheduled by a first DCI, and a second uplink transmission to a second TRP may be scheduled by a second DCI. Simultaneous uplink transmissions may be associated with multiple panels.

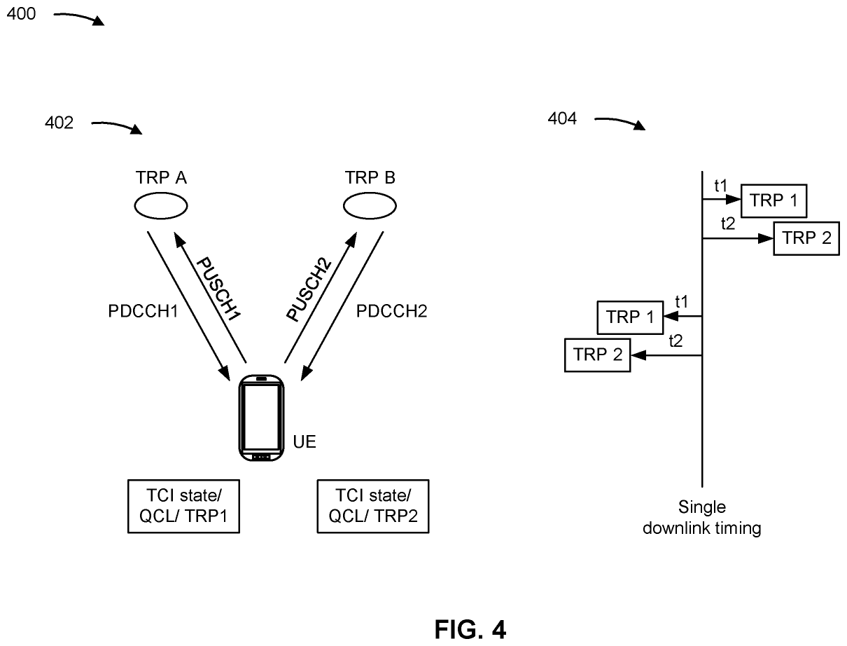

FIG. 4 is a diagram illustrating an example 400 of multiple transmission reception point (multi-TRP) operations, in accordance with the present disclosure.

As shown by reference number 402, a UE may receive a first physical downlink control channel (PDCCH) from a first TRP. The first TRP may be associated with a first transmission configuration indicator (TCI) or a first quasi-co-location (QCL). The UE may transmit, to the first TRP, a first physical uplink shared channel (PUSCH) based at least in part on the first PDCCH. The UE may receive a second PDCCH from a second TRP. The second TRP may be associated with a second TCI or a second QCL. The UE may transmit, to the second TRP, a second PUSCH based at least in part on the second PDCCH.

As shown by reference number 404, a UE may apply a single downlink timing. The UE may have a TA value per TRP. Propagation delays from different TRPs may be different. For an uplink transmission, in order to compensate for a propagation delay, the UE may apply different TA values for the different TRPs. The UE may apply the different TA values for uplink transmissions associated with the different TRPs. For example, when a propagation delay from a first TRP at the UE is t1, the UE may advance uplink transmissions by a value that is based at least in part on t1. As another example, when a propagation delay from a second TRP at the UE is t2, the UE may advance uplink transmissions by a value that is based at least in part on t2.

As indicated above, FIG. 4 is provided as an example. Other examples may differ from what is described with regard to FIG. 4.

A UE may signal, to a network entity, a supported number of TAGs (supportedNumberTAG) parameter. The supportedNumberTAG parameter may define a quantity of TAGs supported by the UE. The supportedNumberTAG parameter may be applied to NR carrier aggregation (CA), NR dual connectivity (DC), next generation (NG) evolved universal terrestrial radio access network (E-UTRAN) NR DC (EN-DC), NG evolved universal terrestrial radio access (E-UTRA) DC (NE-DC), or dual active protocol stack (DAPS) handover. For (NG) EN-DC/NE-DC, the supportedNumberTAG parameter may indicate a quantity of TAGs for an NR configured grant (CG). For an NR CA/NR-DC band combination, when the band combination is associated with more than one band entry (e.g., an inter-band or intra-band non-contiguous band combination), the supportedNumberTAG parameter may indicates that different TA values on different band entries may be supported. The UE may support more than one TAG for NR-DC. The UE may support two TAGs for inter-frequency DAPS.

The UE may signal, to the network entity, a multi-DCI multi-TRP (multiDCI-MultiTRP-r16) parameter. The multiDCI-MultiTRP-r16 parameter may indicate whether the UE is capable of supporting multi-DCI based multi-TRP, and whether the UE is capable of supporting physical downlink shared channels (PDSCHs) that are fully/partially overlapping in time and non-overlapping in frequency. A multi-DCI based multi-TRP capability may apply to bandwidth parts (BWPs) in which two control resource set (CORESET) pool index values are configured. The multiDCI-MultiTRP-r16 parameter may indicate a maximum quantity of CORESETs configured per BWP per cell in addition to CORESET 0. The multiDCI-MultiTRP-r16 parameter may indicate a maximum quantity of CORESETs configured per CORESET pool index per BWP per cell in addition to CORESET 0. The multiDCI-MultiTRP-r16 parameter may indicate a maximum quantity of unicast PDSCHs per CORESET pool index per slot. Different TRPs may be associated with different CORESET pool indexes.

The UE may signal, to the network entity, a beam management (beamManagementType-r16) parameter, which may indicate a supported beam management type for inter-band carrier aggregation within FR2. A beam management type may be independent beam management (IBM) or common beam management (CBM).

A UE may have hardware restrictions when applying independent TA values for different component carriers (CCs), for example, due to CBM. The UE may support the different CCs in a carrier aggregation. The UE may apply the CBM for the different CCs in the carrier aggregation, in which case different uplink transmissions may share a common beam. In this case, the UE cannot have different TA values for the different CCs, and instead the UE may need to be indicated with independent TA values for the different CCs configured with the CBM. The hardware restrictions at the UE may prevent the UE from applying the independent TA values for the different CCs.

In various aspects of techniques and apparatuses described herein, a UE may transmit, to a network entity, a report associated with a UE capability for supporting a common TA configuration. The report may indicate a supported TA type, which may include an independent TA and/or a common TA. The report may indicate a quantity of TAGs for a carrier aggregation. The report may be based at least in part on hardware restrictions at the UE. The UE may receive, from the network entity, a TA configuration based at least in part on the report. The TA configuration may be based at least in part on the supported TA type and/or the quantity of TAGs for the carrier aggregation. In other words, the TA configuration may comply with the hardware restrictions of the UE. The UE may apply TA values to uplink channels and/or uplink reference signals based at least in part on the TA configuration, such that the UE may apply the TA values in accordance with the UE capability.

FIG. 5 is a diagram illustrating an example 500 associated with reporting common TA configuration capabilities, in accordance with the present disclosure. As shown in FIG. 5, example 500 includes communication between a UE (e.g., UE 120) and a network entity (e.g., base station 110). In some aspects, the UE and the network entity may be included in a wireless network, such as wireless network 100.

In some aspects, the UE may support multi-TRP operations. The network entity may be associated with a first TRP and a second TRP. The UE may communicate with the first TRP and the second TRP based at least in part on the multi-TRP operations.

As shown by reference number 502, the UE may transmit, to the network entity, a report associated with a UE capability for supporting a common TA configuration. The UE capability for supporting the common TA configuration may be based at least in part on hardware restrictions at the UE. When the UE supports the common TA configuration, the UE may be able to apply a common TA to multiple resources. For example, the multiple resources may be one or more CCs and/or one or more bands. In another example, the multiple resources may be one or more TRPs. In some aspects, the UE may transmit the report on a per TRP basis. For example, the UE may transmit the report separately for the first TRP and the second TRP.

In some aspects, the UE may indicate, in the report, a supported TA type. The supported TA type may be, for example, for inter-band carrier aggregation within FR2. The supported TA type may be an independent TA or a common TA. When the supported TA type is the independent TA, the UE may be capable of applying separate TAs for different resources. The different resources may be different CCs and/or bands. The UE may apply the independent TA for uplink channels or reference signals associated with the different CCs and/or bands. When the supported TA type is the common TA, the UE may be capable of applying a common TA across different CCs and/or bands. The UE may apply the common TA for uplink channels or reference signals across the different CCs and/or bands.

In some aspects, the report may be per band combination, where a band combination may refer to a combination of one or more bands. The report may indicate the supported TA type, such as the independent TA or the common TA, for one band combination. In some aspects, the report may be per band and per band combination. The report may indicate the supported TA type, such as the independent TA or the common TA, for one band in the band combination.

In some aspects, the common TA may not be configured as multiple independent TAs. The multiple independent TAs may be configured as the common TA. In other words, the common TA may not be configured as the multiple independent TAs, but the multiple independent TAs may be configured as the common TA.

In some aspects, the UE may indicate, in the report, a required minimum quantity of TA configurations (e.g., a quantity of TAGs required for a carrier aggregation configuration). The report may indicate a quantity of TAGs for a carrier aggregation. In some aspects, the report may indicate, for the quantity of TAGs for the carrier aggregation, a set of bands associated with a common TAG per band combination. In other words, the UE may report the set of bands that are required to have the common TAG per band combination. In some aspects, the report may indicate, for the quantity of TAGs for the carrier aggregation, a set of CCs associated with a common TAG per band and per band combination. In other words, the UE may report the set of CCs that are required to have the common TAG per band and per band combination.

In some aspects, when the UE is capable of the multi-TRP operations, the UE may indicate, in the report, the supported TA type and/or the required minimum quantity of TA configurations. In some aspects, the UE may indicate the supported TA type and/or the required minimum quantity of TA configurations on a per TRP basis, where a common TA may be configured per TRP based at least in part on the report. The UE may transmit the report on the per TRP basis based at least in part on the multi-TRP operations being supported at the UE. In some aspects, the UE may indicate the supported TA type and/or the required minimum quantity of TA configurations on a joint TRP basis, where a common TA may be configured across TRPs based at least in part on the report. The UE may transmit the report on the joint TRP basis based at least in part on the multi-TRP operations being supported at the UE.

As shown by reference number 504, the UE may receive, from the network entity, a TA configuration based at least in part on the report. The TA configuration may configure the UE with a common TA, depending on the reporting associated with the UE capability for supporting the common TA configuration. The TA configuration may be based at least in part on the supported TA type and/or the quantity of TAGs for the carrier aggregation, as reported by the UE. The TA configuration received from the network entity may not violate the UE capability indicated in the report. As a result, the hardware restrictions at the UE may not prevent the UE from implementing the TA configuration received from the network entity, since the TA configuration may be based at least in part on the hardware restrictions at the UE.

In some aspects, the UE may apply TA values to uplink channels and/or uplink reference signals based at least in part on the TA configuration received from the network entity. For example, the UE may apply the common TA to the uplink channels and/or the uplink reference signals based at least in part on the TA configuration received from the network entity. The UE may apply the common TA to the uplink channels and/or the uplink reference signals in accordance with the UE capability.

In some aspects, the report may be per band combination. When the UE reports that the supported TA type is the independent TA, the TA configuration received from the network entity may indicate an independent TAG for each band in the band combination. In other words, the UE may be configured with the independent TAG for each band in the band combination. When the UE reports that the supported TA type is the common TA, the TA configuration received from the network may indicate a common TAG for a plurality of bands in the band combination. In other words, the UE may be configured with the common TAG for the plurality of bands (e.g., all bands) in the band combination.

In some aspects, the report may be per band and per band combination. When the UE reports that the supported TA type is the independent TA, the TA configuration received from the network entity may indicate an independent TAG for each CC in one band in the band combination. In other words, the UE may be configured with the independent TAG for each CC in the one band in the band combination. When the UE reports that the supported TA type is the common TA, the TA configuration received from the network may indicate a common TAG for a plurality of CCs in one band in the band combination. In other words, the UE may be configured with the common TAG for the plurality of CCs (e.g., all CCs) in the one band of the band combination.

In some aspects, the TA configuration may indicate the common TA for a set of bands that support a CBM type. The UE may expect to be configured with the common TA for the set of bands which are indicated, by the UE, as supporting CBM. In some aspects, the TA configuration may indicate the independent TA for a set of bands that support an IBM type. The UE may expect to be configured with an independent TA for a set of bands which are indicated, by the UE, as supporting IBM.

As indicated above, FIG. 5 is provided as an example. Other examples may differ from what is described with regard to FIG. 5.

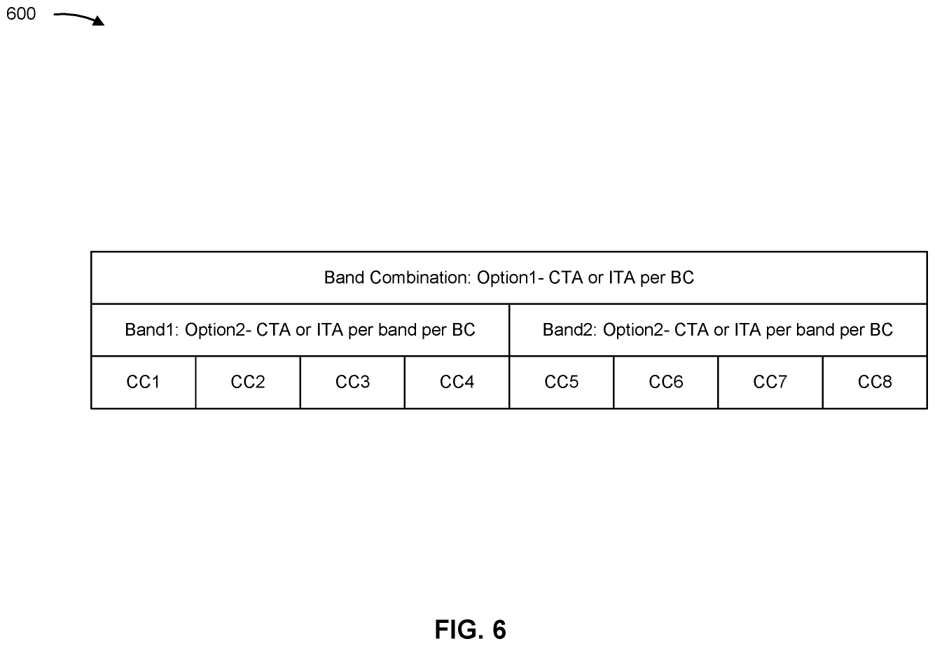

FIG. 6 is a diagram illustrating an example 600 associated with reporting common TA configuration capabilities, in accordance with the present disclosure.

As shown in FIG. 6, in a first option, a UE may be configured with a common TA or an independent TA per band combination (BC). The band combination may be associated with a first band and a second band. In a second option, the UE may be configured with a common TA (CTA) or an independent TA (ITA) per band and per band combination. For example, the UE may be configured with a common TA or an independent TA for the first band, and the UE may be configured with a common TA or an independent TA for the second band. The first band may be associated with CC0, CC1, CC2, and CC3. The second band may be associated with CC4, CC5, CC6, and CC7.

As indicated above, FIG. 6 is provided as an example. Other examples may differ from what is described with regard to FIG. 6.

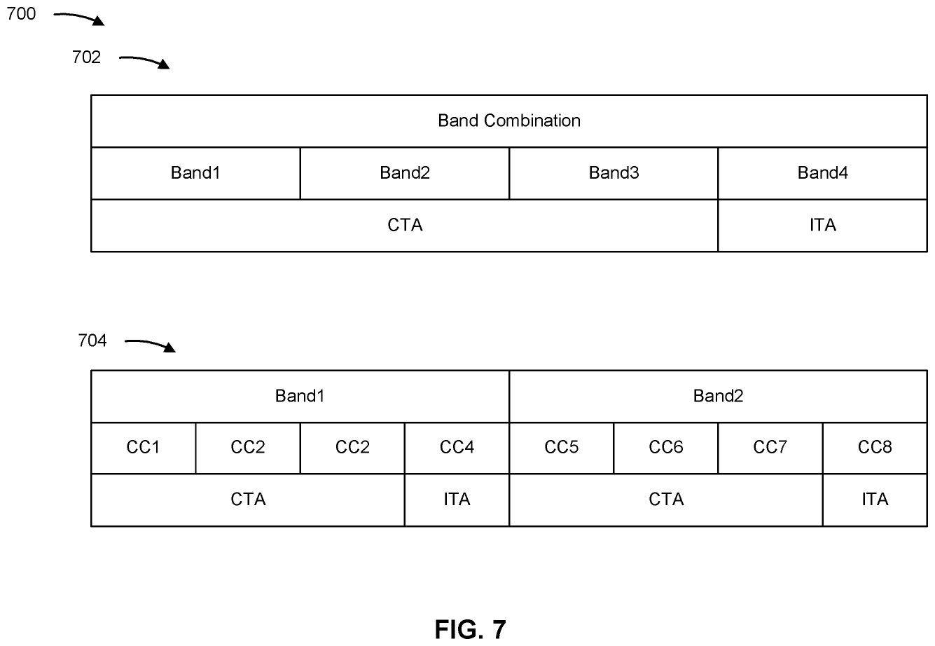

FIG. 7 is a diagram illustrating an example 700 associated with reporting common TA configuration capabilities, in accordance with the present disclosure.

As shown by reference number 702, a UE may report a set of bands that are required to have a common TAG per band combination. For example, the UE may indicate that a first band, a second band, and a third band are associated with a common TA. The first band, the second band, and the third band may be associated with a common TAG. The UE may indicate that a fourth band is associated with an independent TA.

As shown by reference number 704, a UE may report a set of CCs that are required to have a common TAG per band and per band combination. For example, the UE may indicate that CC1, CC2, and CC3 are associated with a common TA. CC1, CC2, and CC3 may be associated with a common TAG. The UE may indicate that CC4 is associated with an independent TA. The UE may indicate that CC5, CC6, and CC7 are associated with a common TA. CC5, CC6, and CC7 may be associated with a common TAG. The UE may indicate that CC8 is associated with an independent TA.

As indicated above, FIG. 7 is provided as an example. Other examples may differ from what is described with regard to FIG. 7.

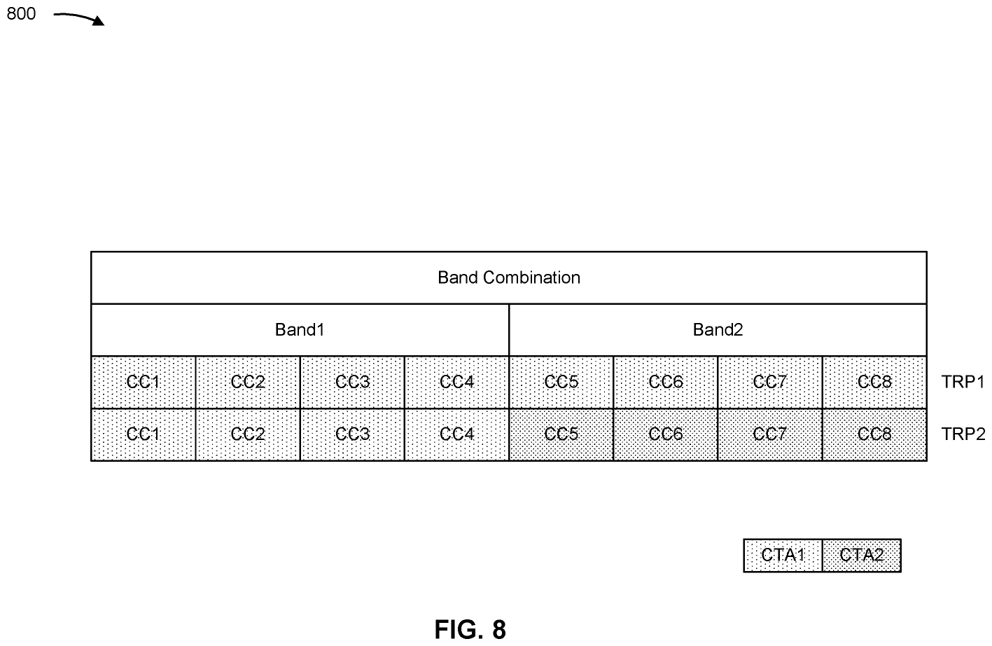

FIG. 8 is a diagram illustrating an example 800 associated with reporting common TA configuration capabilities, in accordance with the present disclosure.

As shown in FIG. 8, a UE may report a supported TA type and/or a required minimum quantity of TA configurations on a per-TRP basis, where a common TA may be configured across TRPs. For example, the UE may indicate that a first common TA is supported for a first TRP, and that both the first common TA and a second common TA are supported for a second TRP. For the first TRP, the first common TA may be associated with both a first band and a second band. For the second TRP, the first common TA may be associated with the first band, and the second common TA may be associated with the second band. The UE may apply the first common TA or the second common TA to uplink channels or uplink reference signals, accordingly, depending on an associated TRP and band.

As indicated above, FIG. 8 is provided as an example. Other examples may differ from what is described with regard to FIG. 8.

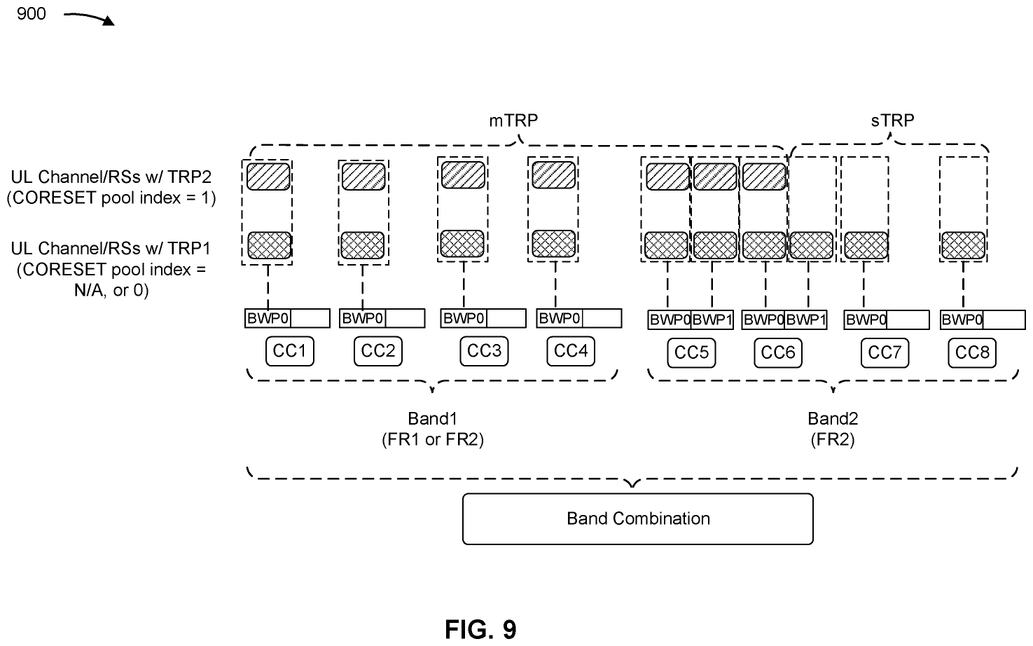

FIG. 9 is a diagram illustrating an example 900 associated with a multi-TRP configuration, in accordance with the present disclosure.

A UE may be configured with a band combination, which may include a first band (Band 1) and a second band (Band 2). The first band may be associated with FR1 or FR2, and the second band may be associated with FR2. The first band may be associated with different CCs, such as CC1, CC2, CC3, and CC4. The second band may be associated with different CCs, such as CC5, CC6, CC7, and CC8. A CC may be associated with one or more BWPs. A BWP may be associated with multiple TRPs or a single TRP. A BWP may be associated with an uplink channel or uplink reference signal, which may be associated with a first TRP (e.g., associated with the CORESETs of CORESET pool index 0, or of no CORESET pool index). A BWP may be associated with an uplink channel or uplink reference signal, which may be associated with a second TRP (e.g., associated with the CORESETs of CORESET pool index=1).

As shown in FIG. 9, CC6 may be configured with BWP0 and BWP1. BWP0 may be configured with the multiple TRPs. BWP0 may be configured with an uplink channel or uplink reference signal, which may be associated with the first TRP. BWP0 may also be configured with an uplink channel or uplink reference signal, which may be associated with the second TRP. BWP1 may be configured with the single TRP. BWP1 may be configured with an uplink channel or uplink reference signal, which may be associated with the first TRP.

As indicated above, FIG. 9 is provided as an example. Other examples may differ from what is described with regard to FIG. 9.

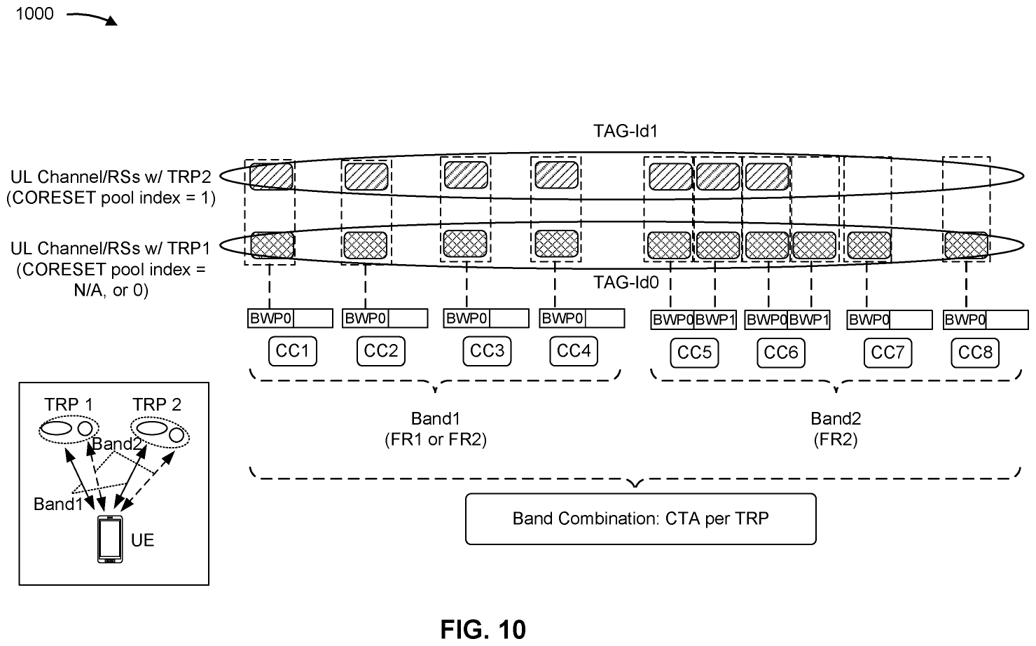

FIG. 10 is a diagram illustrating an example 1000 associated with a TAG configuration, in accordance with the present disclosure.

As shown in FIG. 10, a first band may support communications between a UE and a first TRP, and communications between the UE and a second TRP. A second band may support communications between the UE and the first TRP, and communications between the UE and the second TRP. As further shown in FIG. 10, the UE may support a common TA per band combination. Uplink channels or uplink reference signals associated with the first TRP may be associated with a first TAG ID (e.g., TAG-Id0). The first TAG ID may be common for the first band and the second band associated with the first TRP, where the first band and the second band may be associated with different CCs. The UE may apply a common TA associated with the first TAG ID for the uplink channels or the uplink reference signals associated with the first TRP. Uplink channels or uplink reference signals associated with the second TRP may be associated with a second TAG ID (e.g., TAG-Id1). The second TAG ID may be common for the first band and the second band associated with the second TRP. The UE may apply a common TA associated with the second TAG ID for the uplink channels or the uplink reference signals associated with the second TRP.

As indicated above, FIG. 10 is provided as an example. Other examples may differ from what is described with regard to FIG. 10.

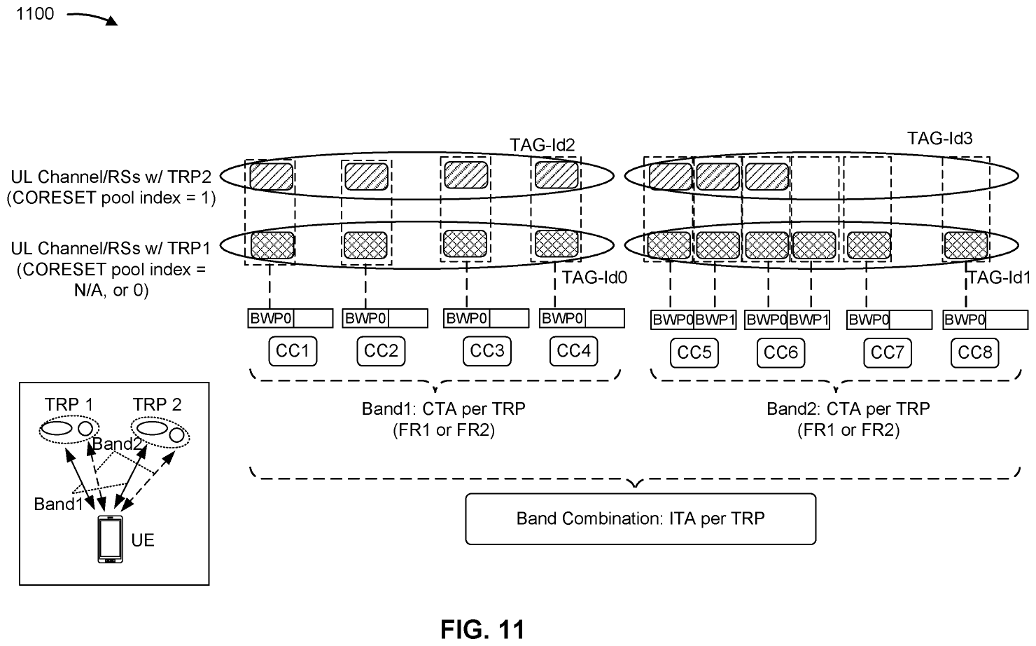

FIG. 11 is a diagram illustrating an example 1100 associated with a TAG configuration, in accordance with the present disclosure.

As shown in FIG. 11, a first band may support communications between a UE and a first TRP, and communications between the UE and a second TRP. A second band may support communications between the UE and the first TRP, and communications between the UE and the second TRP. As further shown in FIG. 11, the UE may support an independent TA per band and per band combination. A band combination may include the first band and the second band. The first band and the second band may each support a common TA per TRP. Uplink channels or uplink reference signals associated with the first TRP and the first band may be associated with a first TAG ID (e.g., TAG-Id0). Uplink channels or uplink reference signals associated with the first TRP and the second band may be associated with a second TAG ID (e.g., TAG-Id1). Uplink channels or uplink reference signals associated with the second TRP and the first band may be associated with a third TAG ID (e.g., TAG-Id2). Uplink channels or uplink reference signals associated with the second TRP and the second band may be associated with a fourth TAG ID (e.g., TAG-Id3).

As indicated above, FIG. 11 is provided as an example. Other examples may differ from what is described with regard to FIG. 11.

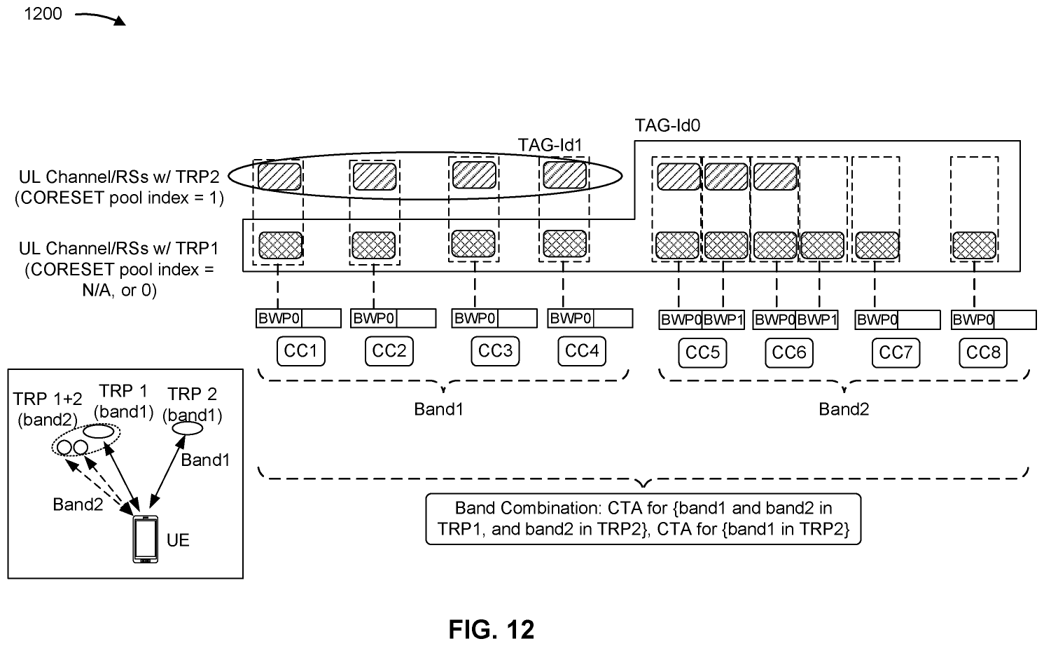

FIG. 12 is a diagram illustrating an example 1200 associated with a TAG configuration, in accordance with the present disclosure.

As shown in FIG. 12, a first band may support communications between a UE and a first TRP. The first band may support communications between the UE and a second TRP. A second band may support communications between the UE and the first TRP, and communications between the UE and the second TRP. As further shown in FIG. 12, the UE may support a common TA for the first band associated with the first TRP, the second band associated with the first TRP, and the second band associated with the second TRP. Uplink channels or uplink reference signals of the first band associated with the first TRP, the second band associated with the first TRP, and the second band associated with the second TRP may be associated with a first TAG ID (e.g., TAG-Id0). The UE may apply a common TA associated with the first TAG ID for the uplink channels or the uplink reference signals of the first band associated with the first TRP, the second band associated with the first TRP, and the second band associated with the second TRP. The UE may support a common TA for the first band associated with the second TRP. Uplink channels or uplink reference signals of the first band associated with the second TRP may be associated with a second TAG ID (e.g., TAG-Id1). The UE may apply a common TA associated with the second TAG ID for the uplink channels or uplink reference signals of the first band associated with the second TRP.

As indicated above, FIG. 12 is provided as an example. Other examples may differ from what is described with regard to FIG. 12.

FIG. 13 is a diagram illustrating an example process 1300 performed, for example, by a UE, in accordance with the present disclosure. Example process 1300 is an example where the UE (e.g., UE 120) performs operations associated with reporting common TA configuration capabilities.

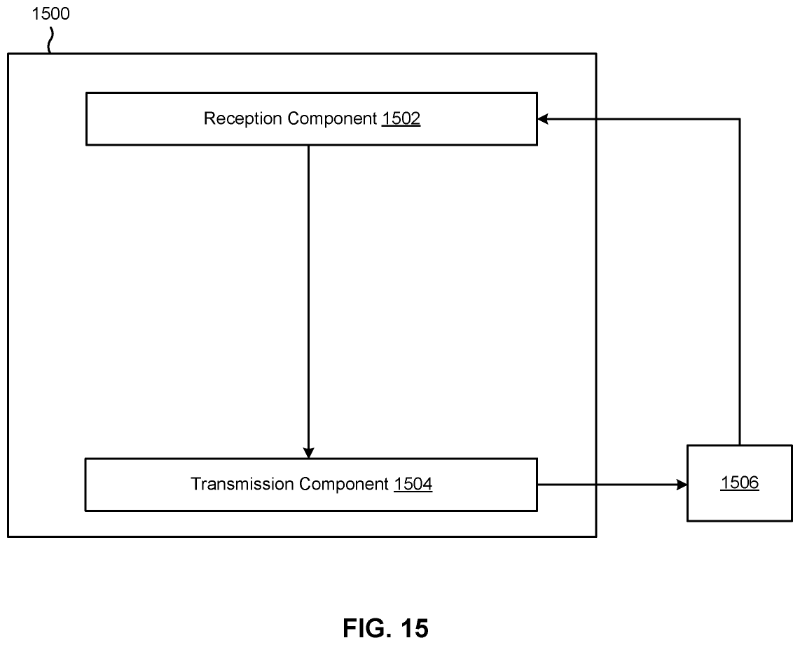

As shown in FIG. 13, in some aspects, process 1300 may include transmitting, to a network entity, a report associated with a UE capability for supporting a common TA configuration, wherein the report indicates one or more of: a supported TA type that includes one of an independent TA or a common TA; or a quantity of TAGs for a carrier aggregation (block 1310). For example, the UE (e.g., using transmission component 1504, depicted in FIG. 15) may transmit, to a network entity, a report associated with a UE capability for supporting a common TA configuration, wherein the report indicates one or more of: a supported TA type that includes one of an independent TA or a common TA; or a quantity of TAGs for a carrier aggregation, as described above.

As further shown in FIG. 13, in some aspects, process 1300 may include receiving, from the network entity, a TA configuration based at least in part on the report (block 1320). For example, the UE (e.g., using reception component 1502, depicted in FIG. 15) may receive, from the network entity, a TA configuration based at least in part on the report, as described above.

Process 1300 may include additional aspects, such as any single aspect or any combination of aspects described below and/or in connection with one or more other processes described elsewhere herein.

In a first aspect, the report is per band combination.

In a second aspect, alone or in combination with the first aspect, the supported TA type is the independent TA, and the TA configuration indicates an independent TAG for each band in the band combination.

In a third aspect, alone or in combination with one or more of the first and second aspects, the supported TA type is the common TA, and the TA configuration indicates a common TAG for a plurality of bands in the band combination.

In a fourth aspect, alone or in combination with one or more of the first through third aspects, the report is per band and per band combination.

In a fifth aspect, alone or in combination with one or more of the first through fourth aspects, the supported TA type is the independent TA, and the TA configuration indicates an independent TAG for each CC in one band in the band combination.

In a sixth aspect, alone or in combination with one or more of the first through fifth aspects, the supported TA type is the common TA, and the TA configuration indicates a common TAG for a plurality of CCs in one band in the band combination.

In a seventh aspect, alone or in combination with one or more of the first through sixth aspects, the common TA is not configured as multiple independent TAs.

In an eighth aspect, alone or in combination with one or more of the first through seventh aspects, multiple independent TAs are configured as the common TA.

In a ninth aspect, alone or in combination with one or more of the first through eighth aspects, for the quantity of TAGs for the carrier aggregation, the report indicates a set of bands associated with a common TAG per band combination.

In a tenth aspect, alone or in combination with one or more of the first through ninth aspects, for the quantity of TAGs for the carrier aggregation, the report indicates a set of CCs associated with a common TAG per band and per band combination.

In an eleventh aspect, alone or in combination with one or more of the first through tenth aspects, process 1300 includes transmitting the report on a per TRP basis based at least in part on multiple TRP operations being supported at the UE, wherein the common TA is configured per TRP based at least in part on the report.

In a twelfth aspect, alone or in combination with one or more of the first through eleventh aspects, process 1300 includes transmitting the report on a joint TRP basis based at least in part on multiple TRP operations being supported at the UE, wherein the common TA is configured across TRPs based at least in part on the report.

In a thirteenth aspect, alone or in combination with one or more of the first through twelfth aspects, the TA configuration indicates the common TA for a set of bands that support a common beam management type, or the TA configuration indicates the independent TA for a set of bands that support an independent beam management type.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a network entity, in accordance with the present disclosure. Example process 1400 is an example where the network entity (e.g., base station 110) performs operations associated with reporting common TA configuration capabilities.

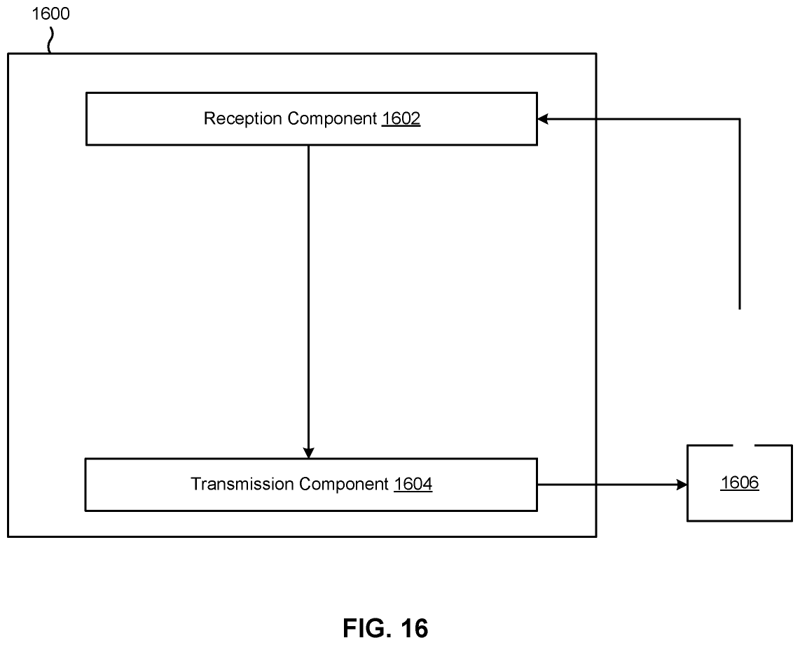

As shown in FIG. 14, in some aspects, process 1400 may include receiving, from a UE, a report associated with a UE capability for supporting a common TA configuration, wherein the report indicates one or more of: a supported TA type that includes one of an independent TA or a common TA; or a quantity of TAGs for a carrier aggregation (block 1410). For example, the network entity (e.g., using reception component 1602, depicted in FIG. 16) may receive, from a UE, a report associated with a UE capability for supporting a common TA configuration, wherein the report indicates one or more of: a supported TA type that includes one of an independent TA or a common TA; or a quantity of TAGs for a carrier aggregation, as described above.

As further shown in FIG. 14, in some aspects, process 1400 may include transmitting, to the UE, a TA configuration based at least in part on the report (block 1420). For example, the network entity (e.g., using transmission component 1604, depicted in FIG. 16) may transmit, to the UE, a TA configuration based at least in part on the report, as described above.

Process 1400 may include additional aspects, such as any single aspect or any combination of aspects described below and/or in connection with one or more other processes described elsewhere herein.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication. The apparatus 1500 may be a UE, or a UE may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504.

In some aspects, the apparatus 1500 may be configured to perform one or more operations described herein in connection with FIGS. 5-12. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

The transmission component 1504 may transmit, to a network entity, a report associated with a UE capability for supporting a common TA configuration, wherein the report indicates one or more of a supported TA type that includes one of an independent TA or a common TA; or a quantity of TAGs for a carrier aggregation. The reception component 1502 may receive, from the network entity, a TA configuration based at least in part on the report.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication. The apparatus 1600 may be a network entity, or a network entity may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604.

In some aspects, the apparatus 1600 may be configured to perform one or more operations described herein in connection with FIGS. 5-12. Additionally, or alternatively, the apparatus 1600 may be configured to perform one or more processes described herein, such as process 1400 of FIG. 14. In some aspects, the apparatus 1600 and/or one or more components shown in FIG. 16 may include one or more components of the network entity described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the network entity described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the network entity described in connection with FIG. 2. In some aspects, the transmission component 1604 may be co-located with the reception component 1602 in a transceiver.

The reception component 1602 may receive, from a UE, a report associated with a UE capability for supporting a common TA configuration, wherein the report indicates one or more of a supported TA type that includes one of an independent TA or a common TA; or a quantity of TAGs for a carrier aggregation. The transmission component 1604 may transmit, to the UE, a TA configuration based at least in part on the report.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by a user equipment (UE), comprising: transmitting, to a network entity, a report associated with a UE capability for supporting a common timing advance (TA) configuration, wherein the report indicates one or more of: a supported TA type that includes one of an independent TA or a common TA; or a quantity of timing advance groups (TAGs) for a carrier aggregation; and receiving, from the network entity, a TA configuration based at least in part on the report.

Aspect 2: The method of Aspect 1, wherein the report is per band combination.

Aspect 3: The method of Aspect 2, wherein the supported TA type is the independent TA, and wherein the TA configuration indicates an independent TAG for each band in the band combination.

Aspect 4: The method of Aspect 2, wherein the supported TA type is the common TA, and wherein the TA configuration indicates a common TAG for a plurality of bands in the band combination.

Aspect 5: The method of any of Aspects 1 through 4, wherein the report is per band and per band combination.

Aspect 6: The method of Aspect 5, wherein the supported TA type is the independent TA, and wherein the TA configuration indicates an independent TAG for each component carrier in one band in the band combination.

Aspect 7: The method of Aspect 5, wherein the supported TA type is the common TA, and wherein the TA configuration indicates a common TAG for a plurality of component carriers in one band in the band combination.

Aspect 8: The method of any of Aspects 1 through 7, wherein the common TA is not configured as multiple independent TAs.

Aspect 9: The method of any of Aspects 1 through 8, wherein multiple independent TAs are configured as the common TA.

Aspect 10: The method of any of Aspects 1 through 9, wherein for the quantity of TAGs for the carrier aggregation, the report indicates a set of bands associated with a common TAG per band combination.

Aspect 11: The method of any of Aspects 1 through 10, wherein for the quantity of TAGs for the carrier aggregation, the report indicates a set of component carriers associated with a common TAG per band and per band combination.

Aspect 12: The method of any of Aspects 1 through 11, wherein transmitting the report is on a per transmission reception point (TRP) basis based at least in part on multiple TRP operations being supported at the UE, wherein the common TA is configured per TRP based at least in part on the report.

Aspect 13: The method of any of Aspects 1 through 12, wherein transmitting the report on a joint transmission reception point (TRP) basis based at least in part on multiple TRP operations being supported at the UE, wherein the common TA is configured across TRPs based at least in part on the report.

Aspect 14: The method of any of Aspects 1 through 13, wherein: the TA configuration indicates the common TA for a set of bands that support a common beam management type; or the TA configuration indicates the independent TA for a set of bands that support an independent beam management type.

Aspect 15: A method of wireless communication performed by a network entity, comprising: receiving, from a user equipment (UE), a report associated with a UE capability for supporting a common timing advance (TA) configuration, wherein the report indicates one or more of: a supported TA type that includes one of an independent TA or a common TA; or a quantity of timing advance groups (TAGs) for a carrier aggregation; and transmitting, to the UE, a TA configuration based at least in part on the report.

Aspect 16: An apparatus for wireless communication at a device, comprising a processor; memory coupled with the processor; and instructions stored in the memory and executable by the processor to cause the apparatus to perform the method of one or more of Aspects 1-14.

Aspect 17: A device for wireless communication, comprising a memory and one or more processors coupled to the memory, the one or more processors configured to perform the method of one or more of Aspects 1-14.

Aspect 18: An apparatus for wireless communication, comprising at least one means for performing the method of one or more of Aspects 1-14.

Aspect 19: A non-transitory computer-readable medium storing code for wireless communication, the code comprising instructions executable by a processor to perform the method of one or more of Aspects 1-14.

Aspect 20: A non-transitory computer-readable medium storing a set of instructions for wireless communication, the set of instructions comprising one or more instructions that, when executed by one or more processors of a device, cause the device to perform the method of one or more of Aspects 1-14.

Aspect 21: An apparatus for wireless communication at a device, comprising a processor; memory coupled with the processor; and instructions stored in the memory and executable by the processor to cause the apparatus to perform the method of Aspect 15.

Aspect 22: A device for wireless communication, comprising a memory and one or more processors coupled to the memory, the one or more processors configured to perform the method of Aspect 15.

Aspect 23: An apparatus for wireless communication, comprising at least one means for performing the method of Aspect 15.

Aspect 24: A non-transitory computer-readable medium storing code for wireless communication, the code comprising instructions executable by a processor to perform the method of Aspect 15.

Aspect 25: A non-transitory computer-readable medium storing a set of instructions for wireless communication, the set of instructions comprising one or more instructions that, when executed by one or more processors of a device, cause the device to perform the method of Aspect 15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
transmit, to a network entity, a report associated with a UE capability for supporting a common timing advance (TA) configuration, wherein the report indicates one or more of:
a supported TA type that includes one of an independent TA or a common TA; or
a quantity of timing advance groups (TAGs) for a carrier aggregation; and
receive, from the network entity, a TA configuration based at least in part on the report.

2. The apparatus of claim 1, wherein the report is per band combination.

3. The apparatus of claim 2, wherein the supported TA type is the independent TA, and wherein the TA configuration indicates an independent TAG for each band in the band combination.

4. The apparatus of claim 2, wherein the supported TA type is the common TA, and wherein the TA configuration indicates a common TAG for a plurality of bands in the band combination.

5. The apparatus of claim 1, wherein the report is per band and per band combination.

6. The apparatus of claim 5, wherein the supported TA type is the independent TA, and wherein the TA configuration indicates an independent TAG for each component carrier in one band in the band combination.

7. The apparatus of claim 5, wherein the supported TA type is the common TA, and wherein the TA configuration indicates a common TAG for a plurality of component carriers in one band in the band combination.

8. The apparatus of claim 1, wherein the common TA is not configured as multiple independent TAs.

9. The apparatus of claim 1, wherein multiple independent TAs are configured as the common TA.

10. The apparatus of claim 1, wherein for the quantity of TAGs for the carrier aggregation, the report indicates a set of bands associated with a common TAG per band combination.

11. The apparatus of claim 1, wherein for the quantity of TAGs for the carrier aggregation, the report indicates a set of component carriers associated with a common TAG per band and per band combination.

12. The apparatus of claim 1, wherein the one or more processors are configured to transmit the report on a per transmission reception point (TRP) basis based at least in part on multiple TRP operations being supported at the UE, wherein the common TA is configured per TRP based at least in part on the report.

13. The apparatus of claim 1, wherein the one or more processors are configured to transmit the report on a joint transmission reception point (TRP) basis based at least in part on multiple TRP operations being supported at the UE, wherein the common TA is configured across TRPs based at least in part on the report.

14. The apparatus of claim 1, wherein:
the TA configuration indicates the common TA for a set of bands that support a common beam management type; or
the TA configuration indicates the independent TA for a set of bands that support an independent beam management type.

15. An apparatus for wireless communication at a network entity, comprising:
a memory; and
one or more processors, coupled to the memory, configured to:
receive, from a user equipment (UE), a report associated with a UE capability for supporting a common timing advance (TA) configuration, wherein the report indicates one or more of:
a supported TA type that includes one of an independent TA or a common TA; or
a quantity of timing advance groups (TAGs) for a carrier aggregation; and
transmit, to the UE, a TA configuration based at least in part on the report.

16. A method of wireless communication performed by a user equipment (UE), comprising:
transmitting, to a network entity, a report associated with a UE capability for supporting a common timing advance (TA) configuration, wherein the report indicates one or more of:
a supported TA type that includes one of an independent TA or a common TA; or
a quantity of timing advance groups (TAGs) for a carrier aggregation; and
receiving, from the network entity, a TA configuration based at least in part on the report.

17. The method of claim 16, wherein the report is per band combination.

18. The method of claim 17, wherein the supported TA type is the independent TA, and wherein the TA configuration indicates an independent TAG for each band in the band combination.

19. The method of claim 17, wherein the supported TA type is the common TA, and wherein the TA configuration indicates a common TAG for a plurality of bands in the band combination.

20. The method of claim 16, wherein the report is per band and per band combination.

21. The method of claim 20, wherein the supported TA type is the independent TA, and wherein the TA configuration indicates an independent TAG for each component carrier in one band in the band combination.

22. The method of claim 20, wherein the supported TA type is the common TA, and wherein the TA configuration indicates a common TAG for a plurality of component carriers in one band in the band combination.

23. The method of claim 16, wherein the common TA is not configured as multiple independent TAs.

24. The method of claim 16, wherein multiple independent TAs are configured as the common TA.

25. The method of claim 16, wherein for the quantity of TAGs for the carrier aggregation, the report indicates a set of bands associated with a common TAG per band combination.

26. The method of claim 16, wherein for the quantity of TAGs for the carrier aggregation, the report indicates a set of component carriers associated with a common TAG per band and per band combination.

27. The method of claim 16, wherein transmitting the report is on a per transmission reception point (TRP) basis based at least in part on multiple TRP operations being supported at the UE, wherein the common TA is configured per TRP based at least in part on the report.

28. The method of claim 16, wherein transmitting the report is on a joint transmission reception point (TRP) basis based at least in part on multiple TRP operations being supported at the UE, wherein the common TA is configured across TRPs based at least in part on the report.

29. The method of claim 16, wherein:
the TA configuration indicates the common TA for a set of bands that support a common beam management type; or
the TA configuration indicates the independent TA for a set of bands that support an independent beam management type.

30. A method of wireless communication performed by a network entity, comprising:
receiving, from a user equipment (UE), a report associated with a UE capability for supporting a common timing advance (TA) configuration, wherein the report indicates one or more of:
a supported TA type that includes one of an independent TA or a common TA; or
a quantity of timing advance groups (TAGs) for a carrier aggregation; and
transmitting, to the UE, a TA configuration based at least in part on the report.
